(19) United States
(12) Patent Application Publication
(10) Pub. No.: US 2025/0214593 A1
(43) Pub. Date: Jul. 3, 2025

(54) WEARABLE TECHNOLOGY FOR A REFUSE VEHICLE AND RECHARGING OF WEARABLES

(71) Applicant: Oshkosh Corporation, Oshkosh, WI (US)

(72) Inventors: Brendan Chan, Oshkosh, WI (US); Vince Schad, Oshkosh, WI (US); Johnny Bui, Oshkosh, WI (US); Adeel Sultan, Oshkosh, WI (US); Bennett Unfried, Oshkosh, WI (US); Brian Thomas, Oshkosh, WI (US); Leo Van Kampen, Conestogo (CA); Steve Wagester, Oshkosh, WI (US)

(73) Assignee: Oshkosh Corporation, Oshkosh, WI (US)

(21) Appl. No.: 19/004,121

(22) Filed: Dec. 27, 2024

Related U.S. Application Data
(60) Provisional application No. 63/615,640, filed on Dec. 28, 2023.

(51) Int. Cl. B60W 40/08; B60W 50/08; G06F 1/16; H02J 50/90; H04W 4/029

(52) U.S. Cl. CPC B60W 40/08; B60W 50/08; G06F 1/163; H02J 50/90; H04W 4/029; B60W 2040/0809; B60W 2040/0818; B60W 2554/4041; B60Y 2200/144

(57) ABSTRACT

A vehicle control system for a refuse vehicle includes one or more vehicle sensors configured to obtain vehicle sensor data relating to the refuse vehicle, one or more wearable devices communicatively coupled to the one or more vehicle sensors and configured to obtain wearable data, and processing circuitry configured to obtain the vehicle sensor data and the wearable data, determine a position of the one or more wearable devices relative to the one or more vehicle sensors, and based on the position, control one or more features of the refuse vehicle. A charging system includes one or more wireless charging devices located at a position corresponding to the one or more wearable devices.

### CROSS-REFERENCE TO RELATED APPLICATIONS

This application claims the benefit of and priority to U.S. Provisional Application No. 63/615,640, filed Dec. 28, 2023, the entire contents of which are hereby incorporated by reference herein.

### BACKGROUND

The present disclosure generally relates to the field of refuse vehicles. More specifically, the present disclosure relates to control systems for refuse vehicles.

### SUMMARY

One embodiment relates to a vehicle control system including a control system for controlling operation of a vehicle or a working component thereof. A wearable device is communicatively coupled to the control system and is configured to generate wearable data. The control system is configured to obtain the wearable data; determine a position of the wearable device relative to the vehicle based on the wearable data; and control operation of the vehicle or the working component based on the position.

Another embodiment relates to a charging system for a wearable device. The charging system includes a wireless charging device located within a vehicle at a position corresponding to a wearable device. The wireless charging device is configured to wirelessly charge the wearable device based on a proximity of the wearable device to the charging device. The wireless charging device comprises at least one of a seat device configured to be disposed in a seat of a vehicle, a seatbelt device configured to be disposed in a seatbelt of a vehicle, an armrest device configured to be disposed in an armrest of a vehicle, or a steering wheel device configured to be disposed in a steering wheel of a vehicle.

Another embodiment relates to a method of charging a wearable device, including detecting motion of the wearable device; converting the motion of the wearable device into electrical energy; and charging the wearable device using the electrical energy.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a top view of a refuse vehicle control system showing sensing arcs for a communication interface relating to a refuse vehicle and an operator, according to an exemplary embodiment;

FIG. 2 is a top view of a refuse vehicle control system showing sensing arcs for a communication interface relating to a refuse vehicle and an operator, according to an exemplary embodiment;

FIG. 3 is a diagram of the refuse vehicle control system of either of FIG. 1 or 2, according to an exemplary embodiment;

FIG. 4 is a perspective view of the refuse vehicle of either of FIG. 1 or 2, according to an exemplary embodiment;

FIG. 5 is a perspective view of the refuse vehicle of either of FIG. 1 or 2, according to an exemplary embodiment;

FIG. 6 is a detail view of wireless pendants, according to an exemplary embodiment; and

FIG. 7 is a detail view of the refuse vehicle control system of either of FIG. 1 or 2, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle of the present disclosure (e.g., a refuse vehicle, etc.) includes a control system that is configured to control operations of the vehicle responsive to operator location and/or movement with respect to the vehicle. The methods and systems of the present disclosure determine operator location and/or movement based on wearable data generated by wearable sensors worn by the operator that wirelessly communicate with a control system onboard the vehicle. In the context of a refuse vehicle, the control system may be configured to determine the position of the operator relative to a lift system of the refuse vehicle, and to limit operation of the lift system if the wearable data indicates that the operator is within a threshold distance from the lift system, or if the operator is outside of a cab of the refuse vehicle. The control system may also be configured to limit operation of the vehicle itself (e.g., vehicle speed, engine operation, vehicle controls, etc.) based on the wearable data. For example, the control system may be configured to determine an identity of the operator based on the wearable data, and to limit operation of the vehicle based on the identity, such as by enabling operation of the vehicle only in response to determining that the identity corresponds with an approved list of operators stored in memory.

Referring generally to the FIGURES, a refuse vehicle control system includes a refuse vehicle having one or more sensors and/or a communication interface, and one or more wearable sensors associated with an operator, that are configured to generate sensor data (e.g., wearable data, etc.) based on the operators movements and/or location with respect to the refuse vehicle. The control system receives the sensor data, and based on the sensor data, determines a location of the operator relative to the refuse vehicle and monitor or control operating conditions or functions of the vehicle. For example, the communication interface can include a GPS system configured to determine a location of the operator and a location of the refuse vehicle. Processing circuitry of the refuse vehicle control system may obtain the sensor data from the communication interface and identify the position of the operator relative to the refuse vehicle (e.g., inside the refuse vehicle, outside the refuse vehicle, behind or in front of the refuse vehicle, proximate to the refuse vehicle, etc.). The processing circuitry may control one or more features of the refuse vehicle and enable, disable, or limit a function of the refuse vehicle (e.g., transit operations, operations of a working component of the refuse vehicle such as a lift system, etc.). The processing circuitry may also be configured to determine the identity of the operator associated with the one or more wearable sensor devices. Based on the identity of the operator, the processing circuitry may also control one or more features of the refuse vehicle and enable, disable, or limit a function of the refuse vehicle. According to an exemplary embodiment, the refuse vehicle may also include a charging system. The charging system may include one or more wireless charging devices disposed within the refuse vehicle at operator-adjacent locations at which the operator is positioned during vehicle operations. The one or more wireless devices may charge the wearable sensor.

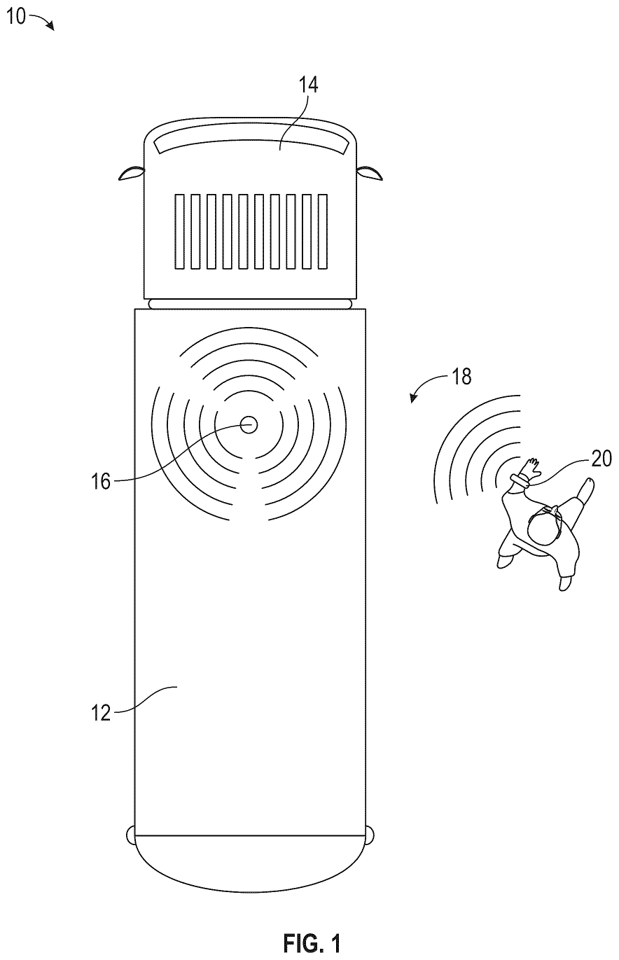

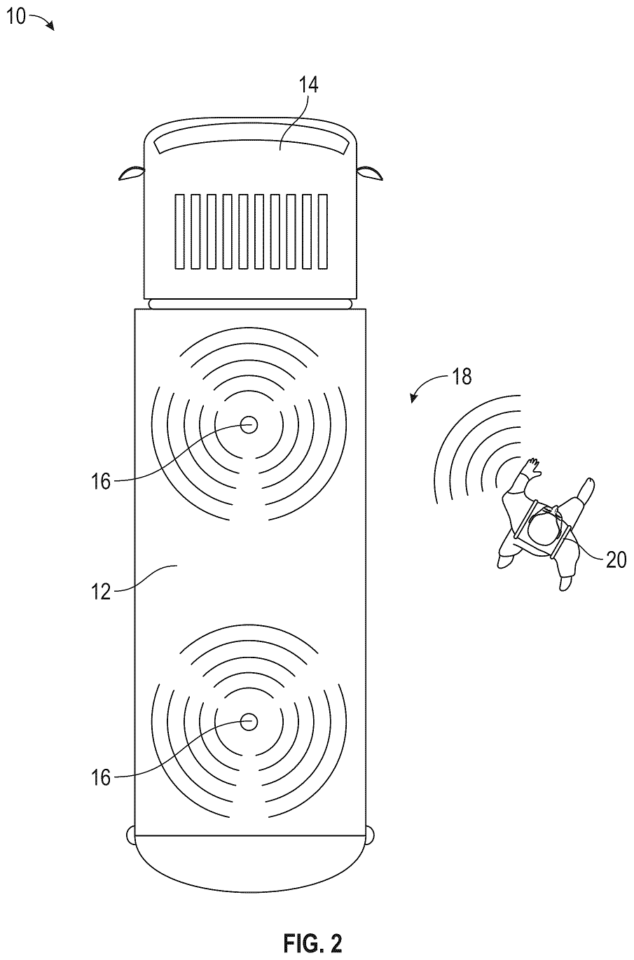

Referring to FIGS. 1 and 2, a vehicle, depicted as a refuse vehicle 10 (e.g., a garbage truck, a waste collection truck, a sanitation truck, etc.), is shown. The refuse vehicle 10 is configured to collect and store refuse along a collection route. The refuse vehicle 10 includes a frame (not shown) coupled to a body assembly, shown as body 12, and a cab, shown as cab 14. The cab 14 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). The refuse vehicle 10 also may include an engine (not shown) coupled to the frame at a position beneath the cab 14. The engine is configured to provide power to tractive elements (e.g., wheels, wheel assemblies, etc.) and/or to other systems of the refuse vehicle 10 (e.g., a pneumatic system, a hydraulic system, etc.). The engine may be configured to utilize one or more of a variety of fuels (e.g., gasoline, diesel, bio-diesel, ethanol, natural gas, etc.), according to various exemplary embodiments. The fuel may be stored in a tank (e.g., a vessel, a container, a capsule, etc.) (not shown) that is fluidly coupled with the engine through one or more fuel lines.

According to an alternative embodiment, the engine additionally or alternatively includes one or more electric motors (not shown) coupled to the frame (e.g., a hybrid refuse vehicle, an electric refuse vehicle, etc.). The electric motors may consume electrical power from any of an on-board storage device (not shown) (e.g., batteries, ultra-capacitors, etc.), from an on-board generator (not shown) (e.g., an internal combustion engine, etc.), or from an external power source (not shown) (e.g., overhead power lines, etc.) and provide power to the systems of the refuse vehicle 10. The engine may transfer output torque to or drive the tractive elements of the refuse vehicle 10 through a transmission (not shown). The engine, the transmission, and one or more shafts, axles, gearboxes, etc., may define a driveline of the refuse vehicle 10.

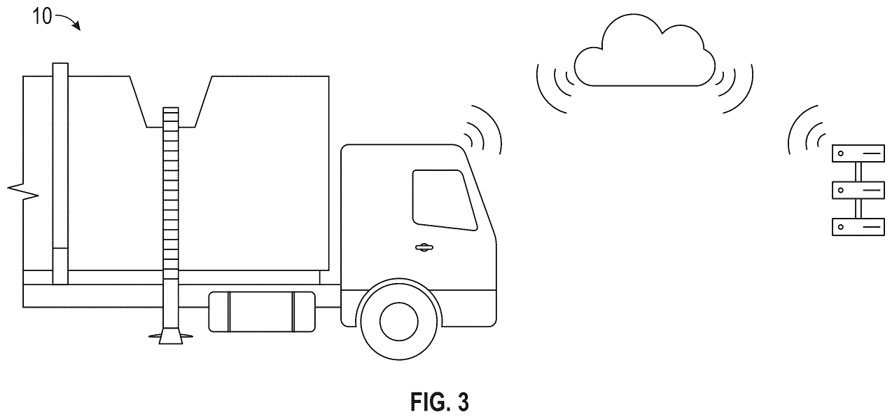

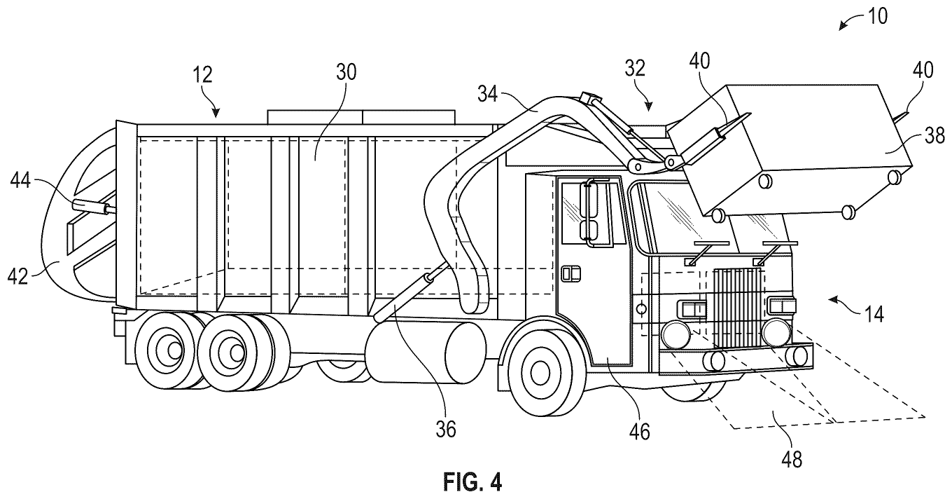

According to an exemplary embodiment, the refuse vehicle 10 is configured to transport refuse from various waste receptacles within a municipality to a storage and/or processing facility (e.g., a landfill, an incineration facility, a recycling facility, etc.). The body 12 includes a plurality of panels defining a collection chamber (e.g., hopper, etc.) (shown in FIGS. 3 and 4).

The refuse vehicle 10 may include a control system that is configured to facilitate autonomous or semi-autonomous operation of the refuse vehicle 10, or components thereof. The control system includes a controller (not shown) that is positioned on the refuse vehicle 10, a remote computing system, a telematics unit, one or more input devices, and one or more controllable elements. The input devices can include the communication interface 16 (e.g., one or more sensors, etc.), a vision system (e.g., an awareness system), a Global Positioning System (“GPS”), and a Human Machine Interface (“HMI”). The controllable elements can include the driveline of the refuse vehicle 10, a braking system of the refuse vehicle 10, a steering system of the refuse vehicle 10, a lift apparatus (e.g., the lift assembly 32, etc.), a compaction system (e.g., a packer assembly, a packer, etc.), body actuators (e.g., tailgate actuators 44, lift or dumping actuators, etc.), a locking and unlocking mechanism, and/or an alert system.

The controller includes processing circuitry including a processor and memory. Processing circuitry can be communicably connected with a communications interface of controller such that processing circuitry and the various components thereof can send and receive data via the communications interface. A processor can be implemented as a general-purpose processor, an application specific integrated circuit (ASIC), one or more field programmable gate arrays (FPGAs), a group of processing components, or other suitable electronic processing components.

The memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory can be or include volatile memory or non-volatile memory. The memory can include database components, object code components, script components, or any other type of information structure for supporting the various activities and information structures described in the present application. According to some embodiments, the memory is communicably connected to the processor via the processing circuitry and includes computer code for executing (e.g., by at least one of the processing circuitry or the processor) one or more processes described herein.

The controller is configured to receive inputs (e.g., measurements, detections, signals, the sensor data, etc.) from the input devices, according to some embodiments. In particular, the controller may receive a GPS location from the GPS system (e.g., current latitude and longitude of the refuse vehicle 10). The controller may receive the sensor data (e.g., engine temperature, fuel levels, transmission control unit feedback, engine control unit feedback, speed of the refuse vehicle 10, etc.) from the communication interface 16. The controller may receive image data (e.g., real-time camera data) from the vision system of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 14 of the refuse vehicle 10, etc.). The controller may receive user inputs from the HMI (e.g., button presses, requests to perform a lifting or loading operation, driving operations, steering operations, braking operations, etc.).

The controller may be configured to provide control outputs (e.g., control decisions, control signals, etc.) to the driveline (e.g., the engine, the transmission, the engine control unit, the transmission control unit, etc.) to operate the driveline to transport the refuse vehicle 10. The controller may also be configured to provide control outputs to the braking system to activate and operate the braking system to decelerate the refuse vehicle 10 (e.g., by activating a friction brake system, a regenerative braking system, etc.). The controller may be configured to provide control outputs to the steering system to operate the steering system to rotate or turn the tractive elements to steer the refuse vehicle 10. The controller may also be configured to operate actuators or motors of the lift apparatus (e.g., lift arm actuators 44) to perform a lifting operation (e.g., to grasp, lift, empty, and return a refuse container). The controller may also be configured to operate the compaction system to compact or pack the refuse that is within the refuse compartment 30. The controller may also be configured to operate the body actuators to implement a dumping operation of the refuse from the refuse compartment 30 (e.g., driving the refuse compartment 30 to rotate to dump the refuse at the landfill). The controller may also be configured to operate the alert system (e.g., lights, speakers, display screens, etc.) to provide one or more aural or visual alerts to nearby individuals.

The controller may also be configured to receive feedback from any of the driveline, the braking system, the steering system, the lift apparatus, the compaction system, the body actuators, or the alert system. The controller may provide any of the feedback to the remote computing system via the telematics unit. The telematics unit may include any wireless transceiver, cellular dongle, communications radios, antennas, etc., to establish wireless communication with the remote computing system. The telematics unit may facilitate communications with telematics units of nearby refuse vehicles 10 to thereby establish a mesh network of refuse vehicles 10.

The controller is configured to use any of the inputs from any of the communication interface 16, the vision system, the GPS system, or the HMI to generate controls for the driveline, the braking system, the steering system, the lift apparatus, the compaction system, the body actuators, or the alert system. In some embodiments, the controller is configured to operate the driveline, the braking system, the steering system, the lift apparatus, the compaction system, the body actuators, and/or the alert system to autonomously transport the refuse vehicle 10 along a route (e.g., self-driving), perform pickups or refuse collection operations autonomously, and transport to a landfill to empty contents of the refuse compartment 30. The controller may receive one or more inputs from the remote computing system such as route data, indications of pickup locations along the route, route updates, customer information, pickup types, etc. The controller may use the inputs from the remote computing system to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system may perform any of the route planning techniques as described in greater detail in U.S. application Ser. No. 18/111,137, filed Feb. 17, 2023, the entire disclosure of which is incorporated by reference herein. The remote computing system may implement any route planning techniques based on data received by the controller. In some embodiments, the controller is configured to implement any of the cart alignment techniques as described in U.S. application Ser. No. 18/242,224, filed Sep. 5, 2023, the entire disclosure of which is incorporated by reference herein. The refuse vehicle 10 and the remote computing system may also operate or implement geofences as described in greater detail in U.S. application Ser. No. 17/232,855, filed Apr. 16, 2021, the entire disclosure of which is incorporated by reference herein.

The remote computing system may determine a route for the refuse vehicle 10. The route may be defined by roads or streets within a neighborhood, a town, a city, etc. The route may include future stops along the route to be completed, and past stops that have already been completed. The route may be defined and provided by the remote computing system. The remote computing system may also define or determine the future stops and the past stops along the route and provide data regarding the geographic location of the future stops and the past stops to the controller of the refuse vehicle 10. The refuse vehicle 10 may use the route data and the stops data to autonomously transport along the route and perform refuse collection at each stop. The route may end at a landfill (e.g., an end location) where the refuse vehicle 10 may autonomously empty collected refuse, transport to a refueling location if necessary, and begin a new route.

Still referring to FIGS. 1 and 2, a wearable system 18 is shown, according to some embodiments. Each system and/or component of the wearable system 18 can include one or more processors, memory, network interfaces, communication interfaces, and/or user interfaces. Memory can store programming logic that, when executed by the processor, controls the operation of the corresponding computing system or device. Memory can also store data in databases. The network interfaces can allow the systems and/or components of the wearable system 18 to communicate wirelessly. The communication interfaces can include wired and/or wireless communication interfaces and the systems and/or components of the wearable system 18 can be connected via the communication interfaces. The various components in the wearable system 18 can be implemented via hardware (e.g., circuitry), software (e.g., executable code), or any combination thereof. Systems, devices, and components in FIGS. 1 and 2 can be added, deleted, integrated, separated, and/or rearranged. The wearable system 18 may implement any of the functionality as described in greater detail in U.S. Application No. 63/529,878, filed Jul. 31, 2021, the entire disclosure of which is incorporated by reference herein.

The wearable system 18 may include at least one of the refuse vehicle 10, the communication interface 16, and at least one wearable sensor and/or wearable device 20. The refuse vehicle 10 may include the various vehicles described herein. The wearable device 20 includes a position module. The position module may wirelessly communicate with the controller of the refuse vehicle 10 through the telematics unit. In some embodiments, the wireless signals may include short-range signals. For example, the short-range signals may include signals in the Ultra-Wideband (UWB) spectrum. The short-range signals may also include other possible wired and/or wireless signal transmission. For example, the short-range signals may include signals transmitted via a Controller Area Network (CAN). As shown in FIG. 3, the wearable system 18 may wirelessly communicate by Bluetooth and/or to a cloud via cellular communications. For example, the wearable device 20 may wirelessly communicate data to the cloud via cellular communications, and the refuse vehicle 10 may also wirelessly communicate with the cloud to obtain the data.

In some embodiments, the wearable device 20 includes and/or is implemented as at least one of a wrist-mounted device (e.g., a watch, etc.), a glove, a jacket, a vest, a hardhat, a helmet, a high visibility article of clothing, a watch, a band, a strap, a pin, etc. For example, the wearable device 20 can be disposed on and/or otherwise include a watch. The wearable device 20 may be worn by at least one individual. For example, the wearable device 20 may be worn by an operator of the refuse vehicle 10. The wearable device 20 may also be worn by at least one individual located at and/or proximate to a post-collection site. For example, the wearable device 20 may be worn by a refuse collection worker.

The processing circuitry of the refuse vehicle 10 may generate, detect, identify, and/or otherwise determine a distance and/or a position of the refuse vehicle 10 relative to the wearable device 20 and/or a position of the wearable device 20 relative to the refuse vehicle 10. For example, the position of the refuse vehicle 10 may be considered an origin and/or a default position and the position of the wearable device 20 may be determined relative to the position of the refuse vehicle 10.

In some embodiments, the processing circuitry may generate zones around the refuse vehicle 10 or may receive predetermined zones from the controller or the remote computing system. The zones or the predetermined zones may represent areas surrounding the refuse vehicle 10. The processing circuitry may generate, detect, identify, and/or otherwise determine a distance and/or a position of the wearable device 20 relative to one or more of the zones or one or more of the predetermined zones. The position of the wearable device 20 within, near, or proximate to one or more of the zones or one or more of the predetermined zones may cause the controller to perform one or more corresponding functions in response.

The refuse vehicle 10 may include one or more vehicle position modules disposed on various portions of the refuse vehicle 10. One or more additional position modules may also be disposed at fixed portions and/or known positions of the refuse vehicle 10 (e.g., portions of the refuse vehicle 10 that may stay relatively unchanged). For example, the vehicle position module may be disposed at communication interface 16 and one of the one or more additional position modules may be disposed on or within the cab 14. The processing circuitry may determine the position of the wearable device 20 based on various aspects of the signals provided to the processing circuitry. For example, the processing circuitry may know a given transmission speed of the signals and then determine the position of the wearable device 20 based on how long it took for the vehicle position modules to receive the signals. Examples of positions of the wearable device 20 relative to the refuse vehicle 10 are shown in FIGS. 1 and 2.

Still referring to FIGS. 1 and 2, the controller may be configured to receive data from radar sensors, camera sensors, the communication interface 16, and/or the wearable system 18 and use the data to operate the driveline, the braking system, the steering system, the alert system, etc. The controller may communicate with the remote computing system via the telematics unit. The controller may upload any of the data obtained from the GPS system, the awareness system, the wearable system 18, etc., to the remote computing system and receive instructions from the remote computing system (e.g., a control signal to reduce a risk to an operator). The controller may use the instructions in combination with awareness data from the awareness system in order to operate the driveline, the braking system, and the steering system to autonomously place the refuse vehicle 10 in a parking configuration. The controller is configured to receive radar data from the radar sensors and image data from the camera sensors. In some embodiments, the controller is configured to receive wearable data from the wearable system 18. The controller includes processing circuitry including a processor and memory. The processing circuitry can be communicably connected with a communications interface of the controller such that the processing circuitry and the various components thereof can send and receive data via the communications interface. The processor can be implemented as a general purpose processor, an application specific integrated circuit (ASIC), one or more field programmable gate arrays (FPGAs), a group of processing components, or other suitable electronic processing components.

The memory includes an object detection manager that is configured to receive the radar data the image data and detect an object using any of or any combination of the radar data and the image data. The object detection manager may be configured determine a type of the object, a distance of the object relative to the refuse vehicle 10 or the operator, and a velocity of the object relative to the refuse vehicle 10 or the operator. For example, the object detection manager may be configured to perform various analyses based on each of the radar data and the image data in order to determine the type of object, to identify the position (e.g., distance) of the object relative to the refuse vehicle 10 or the operator, and to identify a velocity of the object relative to the refuse vehicle 10 or the operator. The object detection manager is configured to implement a radar analysis technique and an image analysis technique.

In some embodiments, the object detection manager is configured to receive the wearable data and determine a position of the wearable device 20 worn by the operator of the refuse vehicle 10. For example, the object detection manager may be configured to perform various analyses based on the wearable data in order to identify the position of the operator relative to the refuse vehicle 10. In some embodiments, the object detection manager is configured to implement a collision analysis technique.

The radar analysis technique can include implementing radar recognition technology (e.g., a neural network, machine learning, artificial intelligence, etc.) to detect types of objects or obstacles that are nearby the refuse vehicle 10. The radar analysis technique may use a database of predetermined objects and labels (e.g., vehicles, refuse containers, buildings, etc., or any other objects that may be commonly encountered nearby the refuse vehicle 10). The radar analysis technique may be implemented in order to determine the type of object. In some embodiments, the radar analysis technique is also configured to estimate the distance between the refuse vehicle 10 and the object. For example, if the awareness system includes multiple of the radar sensors, the object detection manager may use a comparison between the multiple of the radar sensors having different perspectives to identify an estimated distance between the refuse vehicle 10 and the object. In some embodiments, the radar analysis technique is also configured to estimate the velocity of the object relative to the refuse vehicle 10. For example, the object detection manager may use a comparison between the radar data from the radar sensors from different moments of time to identify an estimated velocity of the object relative to the refuse vehicle 10.

The image analysis technique can include implementing image recognition technology (e.g., a neural network, machine learning, artificial intelligence, etc.) to detect types of objects that are nearby the refuse vehicle 10 or the operator. The image analysis technique may use a database of predetermined objects and labels (e.g., vehicles, refuse containers, buildings, etc., or any other objects that may be commonly encountered nearby the refuse vehicle 10). The image analysis technique may be implemented in order to determine the type of objects. In some embodiments, the image analysis technique is also configured to estimate the distance between the refuse vehicle 10 or the operator and the objects. For example, if the awareness system includes multiple of the camera sensors, the object detection manager may use a comparison between the multiple of the camera sensors having different perspectives to identify an estimated distance between the refuse vehicle 10 and the object. In some embodiments, the image analysis technique is also configured to estimate the velocity of the object relative to the refuse vehicle 10 or the operator. For example, the object detection manager may use a comparison between the image data from the camera sensors from different moments of time to identify an estimated velocity of the object relative to the refuse vehicle 10. In some embodiments, the object detection manager may use a combination of the radar analysis technique and the image analysis technique to detect types of objects that are nearby the refuse vehicle 10 or the operator, the distance between the refuse vehicle 10 or the operator and the objects, and the velocity of the objects relative to the refuse vehicle 10 or the operator.

The collision analysis technique can include implementing collision detection technology (e.g., a neural network, machine learning, artificial intelligence, etc.) to predict contact between objects. The collision analysis technique may use a database of predetermined collision parameters (e.g., a velocity of a second vehicle relative to the refuse vehicle 10, etc.). In some embodiments, the collision analysis techniques may use the outputs of at least one of the radar analysis technique or the image analysis technique. The collision analysis technique may be implemented in order to predict that an object may come in contact with the refuse vehicle 10 or the operator. For example, the collision analysis technique may be implemented to predict that a second vehicle may come in contact with the refuse vehicle 10 based on the type, the position, and the velocity of the second vehicle. In some embodiments, the collision analysis technique may be implemented in order to predict that the object may come in contact with a specific portion of the refuse vehicle 10. For example, the collision analysis technique may be implemented to predict that the second vehicle may come in contact with a door 46 (shown in FIGS. 3 and 4) of the refuse vehicle 10 if the door is positioned in an open configuration. In some embodiments, the collision analysis technique is also configured to predict that an object may come in contact with the operator of the refuse vehicle 10. In some embodiments, the collision analysis technique may use the wearable data from the wearable system 18. For example, when the operator is positioned outside of the refuse vehicle 10, the collision analysis technique may be implemented to predict that a second vehicle may come in contact with the operator of the refuse vehicle 10.

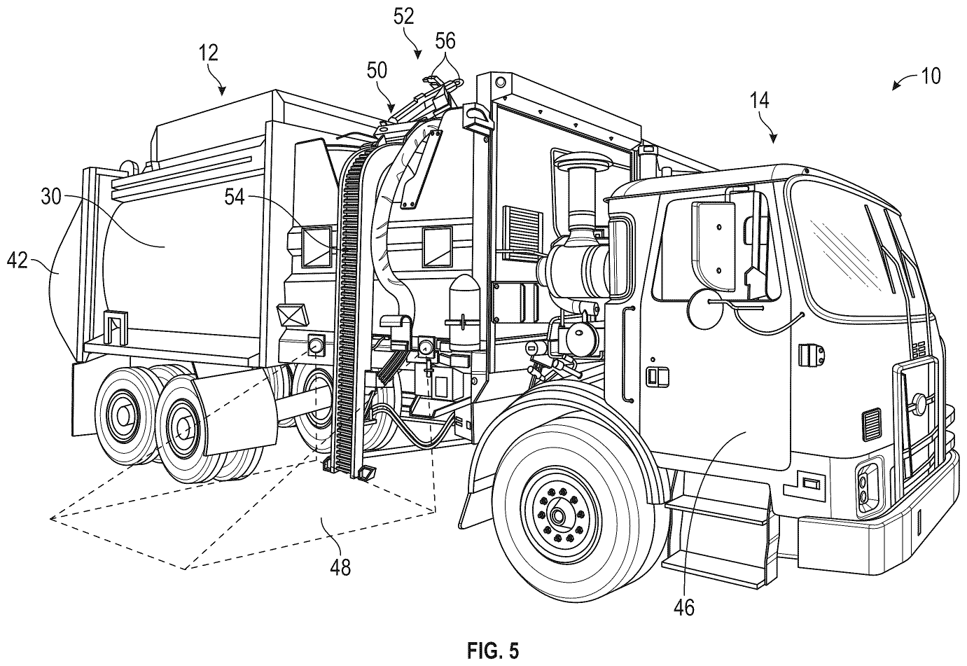

Referring now to FIGS. 4 and 5, the collection chamber is shown as refuse compartment 30. Loose refuse may be placed into the refuse compartment 30 where it may thereafter be compacted. The refuse compartment 30 may provide temporary storage for refuse during transport to a waste disposal site and/or a recycling facility. According to the embodiment shown in FIG. 4, the body 12 and the refuse compartment 30 are positioned behind the cab 14.

In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned between the storage volume and the cab 14 (e.g., refuse is loaded into a position of the refuse compartment 30 behind the cab 14 and stored in a position further toward the rear of the refuse compartment 30).

In the embodiment of FIG. 4, the refuse vehicle 10 is configured as a front-loading refuse vehicle. As shown in FIG. 4, in some embodiments, at least a portion of the body 12 and the refuse compartment 30 extend in front of the cab 14. The hopper volume is positioned forward of the cab 14 (e.g., refuse is loaded into a position of the refuse compartment 30 in front of the cab 14, a front-loading refuse vehicle, etc.). In yet other embodiments, the storage volume is positioned between the hopper volume and the cab 14 (e.g., a rear-loading refuse vehicle, etc.).

The refuse vehicle 10 as shown in FIG. 4 includes a first lift mechanism or system (e.g., a front-loading lift assembly, etc.), shown as the lift assembly 32. The lift assembly 32 includes a pair of arms, shown as lift arms 34, coupled to at least one of the frame or the body 12 on either side of the refuse vehicle 10 such that the lift arms 34 extend forward of the cab 14 (e.g., a front-loading refuse vehicle, etc.). The lift arms 34 may be rotatably coupled to the frame with a pivot (e.g., a lug, a shaft, etc.). The lift assembly 32 includes first actuators, shown as lift arm actuator 36 (e.g., hydraulic cylinders, etc.), coupled to the frame and the lift arms 34. The lift arm actuators 36 are positioned such that extension and retraction thereof rotates the lift arms 34 about an axis extending through the pivot, according to an exemplary embodiment. Lift arms 34 may be removably coupled to a container, shown as refuse container 38. Lift arms 34 are configured to be driven to pivot by lift arm actuators 36 to lift and empty the refuse container 38 into the hopper volume for compaction and storage. The lift arms 34 may be coupled with a pair of elongated members 40, or forks, that are configured to removably couple with the refuse container 38 so that the refuse container 38 can be lifted and emptied. The refuse container 38 may be similar to the container attachment as described in greater detail in U.S. application Ser. No. 17/558,183, filed Dec. 12, 2021, the entire disclosure of which is incorporated by reference herein.

The refuse vehicle 10 may include a tailgate 42. The tailgate 42 may be hingedly or pivotally coupled with the body 12 at a rear end of the body 12 (e.g., opposite the cab 14). The tailgate 42 may be driven to rotate between an open position and a closed position by the tailgate actuators 44. The refuse compartment 30 may be hingedly or pivotally coupled with the frame such that the refuse compartment 30 can be driven to raise or lower while the tailgate 42 is open in order to dump contents of the refuse compartment 30 at a landfill. The refuse compartment 30 may include the packer assembly (not shown) (e.g., a compaction apparatus) positioned therein that is configured to compact loose refuse.

Referring to FIG. 5, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 54, and configured to move along an entire length of track 54. According to the exemplary embodiment shown in FIG. 5, track 54 extends along substantially an entire height of body 12 and is configured to cause grabber assembly 52 to tilt near an upper height of body 12. In other embodiments, the track 54 extends along substantially an entire height of body 12 on a rear side of body 12. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 5, grabber assembly 52 includes a pair of grabber arms shown as grabber arms 56. The grabber arms 56 are configured to rotate about an axis extending through a bushing. The grabber arms 56 are configured to releasably secure the refuse container 38 (shown in FIG. 4) to grabber assembly 52, according to an exemplary embodiment. The grabber arms 56 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 56 are rotated towards each other such that the refuse container 38 is grasped therebetween. In the disengaged state, the grabber arms 56 rotate outwards such that the refuse container 38 is not grasped therebetween. By transitioning between the engaged state and the disengaged state, the grabber assembly 52 releasably couples the refuse container 38 with grabber assembly 52. The refuse vehicle 10 may pull up along-side the refuse container 38, such that the refuse container 38 is positioned to be grasped by the grabber assembly 52 therebetween. The grabber assembly 52 may then transition into an engaged state to grasp the refuse container 38. After the refuse container 38 has been securely grasped, the grabber assembly 52 may be transported along track 54 with the refuse container 38. When the grabber assembly 52 reaches the end of track 54, the grabber assembly 52 may tilt and empty the contents of the refuse container 38 in refuse compartment 30. The tilting is facilitated by the path of the track 54. When the contents of the refuse container 38 have been emptied into refuse compartment 30, the grabber assembly 52 may descend along the track 54 and return the refuse container 38 to the ground. Once the refuse container 38 has been placed on the ground, the grabber assembly may transition into the disengaged state, releasing the refuse container 38.

The refuse vehicle 10 as shown in FIGS. 1-5 includes the awareness system (e.g., a detection system, a vision system, an environmental detection system, an environmental awareness system, etc.) that is configured to adjacent objects, approaching objects, etc. The awareness system may be configured to detect different types of objects such as various types of refuse containers, vehicles, buildings, or any other object that may be adjacent the refuse vehicle 10. The awareness system may use a variety of sensors, detectors, emitters, detection sub-systems, etc., to detect different types of objects. For example, the awareness system may use the vision system or multiple of the communication interface 16 (shown in FIGS. 1 and 2) of the refuse vehicle 10. The awareness system may implement any of the functionality as described in greater detail in U.S. application Ser. No. 17/232,367, filed Apr. 16, 2021, the entire disclosure of which is incorporated by reference herein.

The awareness system may be configured to detect stationary objects proximate the refuse vehicle 10. For example, at least one of the radar sensors or the camera sensors may detect the presence and location of a stationary object, such as refuse container 38, positioned proximate the refuse vehicle 10. The awareness system may also be configured to detect moving objects proximate the refuse vehicle 10. For example, at least one of the radar sensors or the camera sensors may detect the presence and location of a moving object, such as the second vehicle, positioned proximate the refuse vehicle 10. In some embodiments, the awareness system is configured to detect the moving objects proximate the refuse vehicle 10 over a time frame such that the awareness system can detect a velocity of the moving objects relative to the refuse vehicle 10.

The awareness system of the refuse vehicle 10 may be configured to detect objects in a surrounding area of the refuse vehicle 10 that is proximate the refuse vehicle 10. The awareness system may detect a location of a specific object, or may detect the presence of the objects in one or more of the zones or the predetermined zones. In some embodiments, the awareness system may include radar sensors with sensing arcs configured to detect objects in the surrounding area of the refuse vehicle 10. In some embodiments, the radar sensors may be positioned on the exterior of the refuse vehicle 10 such that the sensing arcs of the radar sensors overlap to generate a 360-degree sensing area. In some embodiments, the radar sensors are a combination of long and short-range sensors.

According to some embodiments, the awareness system may include camera sensors with sensing arcs. In some embodiments, the camera sensors may be positioned on the exterior of the refuse vehicle 10 such that the sensing arcs of the camera sensors overlap to generate a 360-degree sensing area. In some embodiments, the camera sensors are a combination of narrow-angle sensors and wide-angle sensors.

According to some embodiments, the awareness system may include a combination of the radar sensors with the sensing arcs and the camera sensors with the sensing arcs. The sensing arcs of the radar sensors and the sensing arcs of the camera sensors may combine to provide 360or near-360 degree coverage of the perimeter of the refuse vehicle 10.

It should be understood that the positioning and arrangement of the communication interface 16, the radar sensors, and/or the camera sensors as described herein is illustrative only and is not intended to be limiting. For example, the communication interface 16 or any of the radar sensors or the camera sensors may be disposed on a top of the cab 14 such that the communication interface 16, the radar sensors, or the camera sensors are configured to detect the presence and relative distance or position of overhead objects, obstacles, etc., proximate the cab 14.

Referring still to FIGS. 1-5, the memory further includes a control manager and a display manager. The control manager is configured to use outputs of the object detection manager in order to implement autonomous operation of the refuse vehicle 10. The control manager can generate control signals for the driveline, the braking system, the steering system, the alert system, or other components of the controllable elements. For example, the control manager can generate control signals for an opening mechanism of the door 46 (e.g., generate control signals for an actuator coupled to the opening mechanism, etc.) to activate the opening mechanism to keep the door 46 in a closed position. In some embodiments, the control manager is configured to operate the driveline, the braking system, and the steering system to autonomously place the refuse vehicle 10 in a parking configuration (e.g., by engaging the parking brake, by placing the transmission in a neutral orientation, etc.). In some embodiments, the control manager is configured to operate the alert system to provide an alert to individuals nearby the refuse vehicle 10. In some embodiments, the control manager is configured to operate the door 46 to adjust the orientation of the door 46 (e.g., activate the opening mechanism to keep the door 46 in the closed orientation, etc.).

It should be understood that any of the functionality of the controller may be implemented on the controller of each of a fleet of the refuse vehicles 10. In some embodiments, one or more functions of the controller are implemented by the controller and one or more functions of the controller are implemented by the remote computing system with which the controller is in communication. Accordingly, any of the functionality of the controller may be performed in a distributed manner between the controller and the remote computing system.

The controller can obtain vehicle data from one or more of the input devices indicating that the vehicle is stopped, according to some embodiments. The vehicle data may indicate that the refuse vehicle 10 is stopped (e.g., not moving, parked, etc.). For example, the vehicle data received by the controller may include GPS data from the GPS system indicating that the position of the refuse vehicle 10 is not changing, the sensor data from the communication interface 16 indicating that the refuse vehicle 10 is not moving (e.g., sensor data from a potentiometer, sensor data from an accelerometer, etc.), the awareness data from the awareness system, wearable data from the wearable system 18, or user inputs from the HMI.

The controller can also determine that the operator of the refuse vehicle 10 is exiting the refuse vehicle 10 or that the operator is outside of the refuse vehicle 10 based on the vehicle data obtained from the one or more of the input devices, according to some embodiments. In some embodiments, the controller may determine that the operator of the refuse vehicle 10 is exiting the cab 14 of the refuse vehicle 10. In some embodiments, the controller may determine that the operator of the refuse vehicle 10 is exiting the cab 14 by identifying a change in sensor data received from a seat sensor (e.g., that the operator is no longer supported by a seat support, etc.), a change in sensor data received from a seat belt sensor (e.g., that the seat belt is no longer securing the operator to the seat support, etc.), a change in sensor data received from a door sensor (e.g., that the door 46 has been adjusted from a closed configuration to the open configuration, that the opening mechanism is not keeping the door 46 in the closed configuration, etc.), or a change in sensor data received from a shift input sensor (e.g., that a shift input device has been adjusted to a park orientation, etc.). In various embodiments, the controller may determine that the operator of the refuse vehicle 10 is exiting the cab 14 through other components of the vehicle data (e.g., through the image data received from the vision system, through the user inputs received from the HMI, etc.).

In some embodiments, the controller may determine that the operator of the refuse vehicle 10 is outside of the refuse vehicle 10 by identifying a position of the wearable device 20 worn by the operator (e.g., that the position of the wearable device 20 worn by the operator is outside of the refuse vehicle 10, etc.), by identifying a position of the operator through the image data received from the vision system (e.g., identifying the operator in the image data and determining that the operator is outside of the refuse vehicle 10, etc.), or by identifying a position of the operator through the user inputs received from the HMI (e.g., receiving a user input from an input device of the HMI that is located outside of the refuse vehicle 10, etc.).

The controller may also identify if the vehicle is in a parked configuration based on vehicle data, according to some embodiments. In some embodiments, the parked configuration may include that at least one of the parking brake of the refuse vehicle 10 is engaged or the transmission is in the neutral orientation. In some embodiments, the controller may identify if the refuse vehicle 10 is in the parked configuration by determining if the parking brake of the refuse vehicle 10 is engaged using the sensor data obtained from a parking brake sensor. In some embodiments, the controller may identify if the refuse vehicle 10 is in the parked configuration by determining if the shift input device is in a neutral position using the sensor data obtained from the shift input sensor. In various embodiments, the controller may identify if the refuse vehicle 10 is in the parked configuration by determining if the parking brake of the refuse vehicle 10 is engaged and if the shift input device is in the neutral position.

The controller may also perform at least one of generating a parking alert or placing the refuse vehicle 10 in the parked configuration, according to some embodiments. The controller can generate the parking alert for the alert system and generate controls for the driveline, braking system, the steering system, etc. of the refuse vehicle 10 in order to place the refuse vehicle 10 in the parked configuration. For example, the controller may generate the parking alert including a parking alarm indicating that the refuse vehicle 10 is not in the parked configuration and provide the parking alert to the alert system. The alert system may provide the parking alarm to nearby individuals (e.g., the operator, etc.) as an aural alert or a visual alert to notify the nearby individuals that the vehicle is not in the parked configuration. The aural alert or the visual alert may notify the operator of the refuse vehicle 10 that the refuse vehicle 10 is not in the parked configuration such that the operator may place the refuse vehicle 10 in the parked configuration. As another example, the controller may also generate controls for the braking system to engage the parking brake of the refuse vehicle 10 in order to engage the parking brake of the refuse vehicle 10, or the controller may generate controls for the driveline to adjust the transmission to the neutral orientation in order to adjust the transmission to the neutral orientation.

The controller can also obtain the awareness data from the awareness system corresponding to a surrounding area proximate the refuse vehicle 10, according to some embodiments. The controller can obtain the awareness data from the awareness system of the refuse vehicle 10 that includes detection of objects positioned within the surrounding area. For example, the awareness data may include the wearable data from the wearable system 18 indicating a position of the wearable device 20 worn by the operator of the refuse vehicle 10. In some embodiments, the awareness data from the awareness system may include detection of the object by one of the radar sensors within the sensing arc of the radar sensor, or detection of the object by one of the camera sensors within the sensing arc of the camera sensor.

The controller may predict, based on the vehicle data corresponding to the refuse vehicle 10 and the awareness data from the awareness system corresponding to the surrounding area of the refuse vehicle 10, that the operator may come in contact with an object in the surrounding area or that the object may come in contact with the operator, according to some embodiments. In some embodiments, the controller may predict that the operator may come in contact with the object after determining that the operator is exiting the refuse vehicle 10 using the vehicle data. The controller may analyze the awareness data from the awareness system and predict that the operator may come in contact with the object if the object is proximate the refuse vehicle 10. In some embodiments, the controller may predict that the operator may come in contact with the object if the object is proximate at least one of the doors 46 of the cab 14. For example, the awareness data from the awareness system may indicate that the refuse container 38 is proximate the door 46 of the refuse vehicle 10 that the operator is exiting. The controller may predict that the operator may come in contact with the refuse container 38 or may contact the refuse container 38 with the door 46.

In some embodiments, the controller may analyze the awareness data from the awareness system and predict that the operator may come in contact with an object that is approaching the refuse vehicle 10. In some embodiments, the controller may analyze the awareness data and predict that the operator may come in contact with the object if the object is approaching at least one of the doors 46 of the cab 14. For example, the awareness data from the awareness system may indicate that the second vehicle is approaching the door 46 of the refuse vehicle 10 and that the operator is exiting the door 46. The controller may predict that the operator or the door 46 may come in contact with the second vehicle that is approaching the door 46 of the refuse vehicle 10 since the operator is exiting the door 46.

In some embodiments, the controller may predict that the operator may come in contact with the object after identifying that the operator is outside of the refuse vehicle 10 using the vehicle data. The controller may analyze the image data received from the vision system and predict that the operator outside of the refuse vehicle 10 may come in contact with the object if the object is approaching the refuse vehicle 10. For example, the visual data received from the vision system may detect that the second vehicle is approaching the refuse vehicle 10. The controller may predict that the operator may come in contact with the second vehicle that is approaching the refuse vehicle 10 since the operator is outside of the refuse vehicle 10.

In some embodiments, the controller may predict that the operator may come in contact with the object after determining a position of the operator outside of the refuse vehicle 10 and determining that the object is approaching the position of the operator outside of the refuse vehicle 10. The controller may determine the position of the operator outside of the vehicle by determining the position of the wearable device 20 worn by the operator using the wearable data from the wearable system 18 or by determining the position of the operator using the awareness data received from the awareness system. For example, the controller may analyze the awareness data received from the awareness system and identify the position of the operator based on the awareness data received from the awareness system. The controller may then analyze the awareness data received from the awareness system and predict that the operator may come in contact with an object approaching the position of the operator outside of the refuse vehicle 10. For example, the controller may analyze the awareness data received from the awareness system to determine a position of the operator outside of the refuse vehicle 10 and that the second vehicle is approaching the position of the operator. The controller may predict that the operator may come in contact with the second vehicle since the second vehicle is approaching the position of the operator. As another example, the controller may analyze the wearable data received from the wearable system 18 to determine a position of the operator outside of the refuse vehicle 10 and the awareness data received from the awareness system to determine that the second vehicle is approaching the position of the operator. The controller may predict that the operator may come in contact with the second vehicle since the second vehicle is approaching the position of the operator.

The controller may also perform at least one of generating an operator alert or operating the refuse vehicle 10 so that the operator may not come in contact with the object, according to some embodiments. The controller can generate the operator alert for the alert system and controls for a driveline, a braking system, a steering system, etc. of the refuse vehicle 10 so that the operator may not come in contact with the object. For example, the controller may generate the operator alert including an operator alarm indicating that the operator is at risk and provide the operator alert to the alert system. The alert system may provide the operator alarm to nearby individuals (e.g., the operator, etc.) as an aural alert or a visual alert to notify the nearby individuals that the operator is at risk. The aural alert or the visual alert may notify the operator of the refuse vehicle 10 that the operator is at risk such that the operator may take actions to reduce the risk to the operator. In some embodiments, the operator alert may differ from the parking alert such that the nearby individuals can tell a difference between the operator alert and the parking alert.

In some embodiments, the controller may generate controls for the driveline, the braking system, the steering system, or one of the controllable elements to so that the operator may not come in contact with the object. For example, if the controller predicts that the operator may come in contact with a second vehicle approaching the door 46 of the refuse vehicle 10 since the operator is exiting the door 46, the controller may generate controls for the opening mechanism of the door 46 to activate the opening mechanism to keep the door 46 in the closed position such that the operator cannot exit the door 46. As another example, if the controller predicts that the operator may come in contact with the second vehicle approaching the refuse vehicle 10, the controller may generate controls for the driveline to transport the refuse vehicle 10 to a position that blocks a path between the second vehicle and the operator such that the second vehicle may not come in contact with the operator.

Referring to FIGS. 4 and 5, the controller may determine that the operator is positioned in a risky location. In FIGS. 4 and 5, the risky location is shown as arm reach envelope 48. In other embodiments, the risky location may be any position relative to the refuse vehicle 10 or another reference point. For example, the controller may analyze the wearable data received from the wearable system 18 to determine a position of the operator outside of the refuse vehicle 10 and the awareness data received from the awareness system to determine that the operator is positioned in or near the risky location. The controller may generate controls for the driveline, the braking system, the steering system, or one of the controllable elements in response to determining that the operator is positioned in or near the risky location. The controller may limit the function of certain features of the refuse vehicle 10. For example, if the operator is positioned within the arm reach envelope 48, the controller may limit function of the lift assembly 32 or the grabber assembly 52. As another example, if the operator is positioned within the arm reach envelope 48, the controller may generate controls for the driveline to transport the refuse vehicle 10 to a position that places the operator in a location relative to the refuse vehicle 10 that is no longer the risky location (e.g., a safe location, etc.).

The controller may limit the function of one or more features of the refuse vehicle 10 in response to determining a position of the operator. Certain features may be limited in function if the operator is located within the body 12, the cab 14, near the tailgate 42, under the refuse vehicle 10, near the wheel of the refuse vehicle 10, near high-voltage components of the refuse vehicle 10, etc. For example, a speed of the refuse vehicle 10 may be limited while the operator is operating the refuse vehicle 10 in a collection-adjacent position within the vehicle (e.g., when the operator is seated in a curbside-adjacent seat position, when the operator is standing within the vehicle cab in a curbside-adjacent standing position, etc.). As another example, certain side-loading collection functions of the refuse vehicle 10 may be limited in response to the operator being in a transit position (e.g., a streetside seat position, etc.). In another example, if the operator is near a high-voltage battery charger, the controller may limit the function of the high-voltage battery charger or prevent charging of a battery until the operator has moved to a location a distance away from the high-voltage battery charger. In an additional example, the controller may disable packing operations of the refuse vehicle 10 if the operator is detected to be in the refuse compartment 30.

The wearable device 20 may act as a beacon or a virtual tether for the control system that follows the operator walking along side, behind, or in front of the vehicle. The controller may generate controls to control the refuse vehicle 10 to remain at a speed or at a distance or a location from the operator such that the refuse vehicle 10 may follow the operator. If the operator is walking alongside the refuse vehicle 10, the controller may generate controls to transport the refuse vehicle 10 while the operator is walking. For example, the refuse vehicle 10 may follow the operator at a predetermined speed. Additionally or alternatively, the refuse vehicle 10 may follow the operator at a dynamic speed such that the refuse vehicle 10 matches a speed of the walking of the operator and increases or decreases speed or stops if the operator increases or decreases speed or stops. The refuse vehicle 10 may also follow the operator at a predetermined distance and may maintain the predetermined distance as the operator is walking.

The wearable system 18 may perform other functions such as monitoring functions.

The wearable system 18 may capture record data relating to the operator leaving the cab 14. The operator may leave the cab 14 to manually collect the refuse or for another reason. The record data may record how often the operator leaves the cab 14 or for how long the operator leaves the cab 14. Based on the record data, the controller may control the communication interface 16 to capture information relating to the operator leaving the cab 14. For example, if the communication interface 16 comprises the camera sensor, the controller may direct the camera to capture an image of the situation or surroundings when the operator leaves the cab 14. The record data may be used to monitor refuse collection times, efficiency or inefficiency, potential problems, etc.

The wearable device 20 may act as a virtual key for the operator of the refuse vehicle 10. The controller may analyze the wearable data received from the wearable system 18 to determine a position of the operator. Based on the position of the operator, the controller may generate controls for one or more features or functions of the refuse vehicle 10. For example, if the controller determines that the operator is located at a position near the door 46, the controller may generate a control for the locking mechanism of the door 46. As the operator is positioned near the door 46 or is approaching the door 46, the controller may control the locking mechanism to lock or unlock the door. Similarly, the controller may generate controls for a starting mechanism of the refuse vehicle 10 to start or stop the engine of the refuse vehicle 10, to turn on one or more lights of the refuse vehicle 10, etc.

Additionally, the wearable device 20 may act as identification for the operator of the refuse vehicle 10. The wearable device 20 may be associated with an identity of the operator. Based on the identity of the operator, the controller may control certain functions or features of the refuse vehicle 10. Conditions such as a status of the operator's training, the status of the operator's driving license, an unauthorized user, etc. may cause the controller to control or limit the function or features of the refuse vehicle 10. For example, the identification of an operator who has not completed training on operating the arms 34 of the refuse vehicle 10 may cause the controller to generate a control to limit function of the arms 34. In some embodiments, a different mechanism (e.g., a badge, a key card, a phone, a tablet, a smart device, a camera, facial recognition, other biometrics, etc.) may act as the identification for the operator and may be sent or uploaded (e.g., by the remote computing system, etc.) to the control system during or in advance of a shift of the operator.

The wearable device 20 may also be configured to detect the operator's readiness to operate. The wearable device 20 may be configured to detect operator impairments by taking vitals measurements or performing other health checks. For example, the wearable device 20 may detect operator impairments such as the operator being under the influence of drugs or alcohol, or the operator having a health issue or emergency. The controller may limit access to the refuse vehicle 10 or may limit certain functions or features of the refuse vehicle 10 if operator impairments are detected. The controller may generate controls to control the locking mechanism, the starting mechanism, or other operating mechanisms, etc. Operator impairments may also be detected at a location associated with a healthcare clinic, an office, a treatment center, etc. and be sent or uploaded (e.g., by the remote computing system, etc.) to the control system during or in advance of the shift of the operator. Such impairment detection may be mandated for operators with a history of addiction, drug or alcohol use or abuse, etc.

In the same or other embodiments, other conditions such as a pre-route inspection status, a status of vehicle maintenance, etc. may cause the controller to control or limit the function or features of the refuse vehicle 10. The functions or features of the refuse vehicle 10 which may be limited in response to any of the conditions, the location of the operator, the identity of the operator, operator impairments, etc. may include starting or stopping the engine of the refuse vehicle 10, refuse functions such as compaction, pump functions, a high voltage disconnect box, etc.

In addition to the operator alert or the parking alert, the controller may generate other alerts and notifications and provide the alerts and notifications to the alert system. For example, the alerts and notifications may relate to approaching vehicles; a status of a condition; a status of the identification of an operator; a status regarding the operator's ability to use or operate certain functions or features of the refuse vehicle 10; a warning; a location of the operator; a location of the refuse vehicle 10; a position or location of certain features or parts of the refuse vehicle 10; a status of the refuse vehicle 10; a position, location, status, or condition of the refuse container 38 or of another object; a status of the wearable device 20; etc. The alert system may provide the alerts and notifications to nearby individuals (e.g., the operator, etc.) as an aural alert or a visual alert to notify the nearby individuals. The alert system may also provide the alerts and notifications as a tactile alert to the wearable device 20.

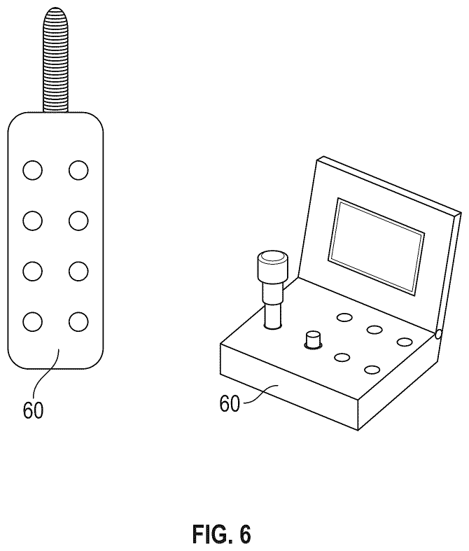

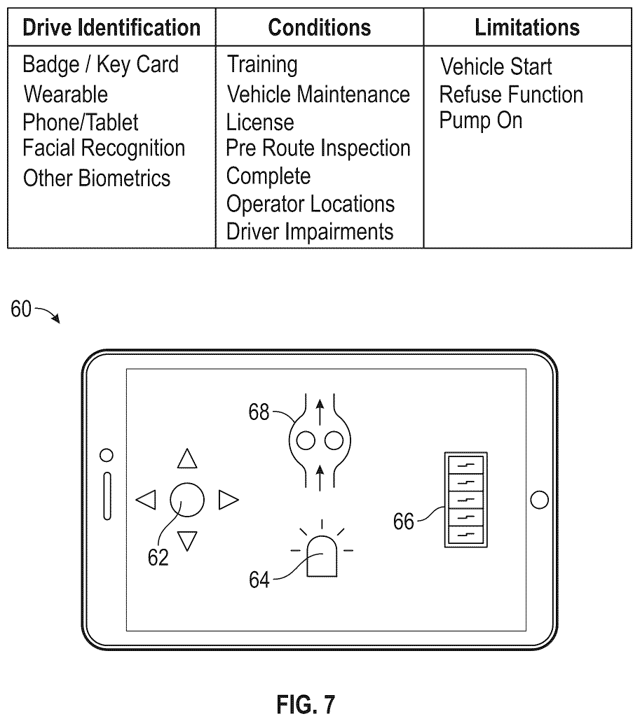

Turning now to FIGS. 6 and 7, exemplary remote pendants 60 (e.g., a smart device, a mobile device, a tablet, a controller device, etc.), are shown. The remote pendants 60 may perform the same or alternative functions as the wearable device 20 or the controller. For example, the operator may use the remote pendant 60 to control the lift arms, turn a set of lights corresponding to the refuse vehicle on or off, control the grabber assembly 52, turn the pump on or off, etc. As shown in FIG. 7, the remote pendant 60 features arm controls 62, light controls 64, grabber controls 66, and pump controls 68. The remote pendant 60 may include other controls or features and may perform other functions. In other embodiments, the remote pendant 60 may be configured to receive controls from the controller. For example, the controller may generate controls to limit the function of the remote pendant 60. Also shown in FIG. 7, the controller may manage conditions or limitations based on an identification of a driver or operator. Based on wearable device 20 and/or the remote pendant 60 (e.g., a badge, key card, a phone, a tablet, facial recognition or other biometrics, etc.), certain conditions relating to training, vehicle maintenance, licensure, pre-route inspection, operator or driver location, operator or driver impairment, etc. may be controlled or limited. Such limitations may include vehicle start, refuse function, and/or other controls of the vehicle (e.g., pump control), etc.

The display manager is configured generate a graphical user interface (“GUI”) for an operator or user of the refuse vehicle 10. The display manager may generate the GUI based on the results of the object detection manager or the data obtained from the GPS system, the awareness system, the wearable system, etc. For example, the display manager is configured to obtain the results of the object detection manager and produce graphical displays of any objects that are detected. The display manager is configured to generate an overlaid GUI and provide the overlaid GUI to a user interface (e.g., a display screen, a touch screen, etc.). The overlaid GUI may include ghost or phantom images of the objects detected by the object detection manager superimposed over image data of a surrounding area of the refuse vehicle 10. The overlaid GUI may also include representations of the operator which correspond to a real-life or real-time position of the operator. The user interface may be positioned locally at the refuse vehicle 10, on the remote pendant 60, at a remote location (e.g., at an operator or technician center for fleet management purposes), etc.

According to an exemplary embodiment, the wearable system 18 may include the charging system (not shown). The charging system includes one or more charging devices located within the refuse vehicle 10 at a charging position corresponding to one or more of the wearable devices 20. The charging device may be a wireless device, a charging pad, a charging coil, and/or another device. When the operator is at the charging position, the wearable device 20 may connect to the charging device such that the wearable device 20 is charged by the charging device. The wearable device 20 may connect to the charging device via a wireless connection and may or may not directly come in contact with the charging device. The charging device may be a seat device, a seatbelt device, a jacket device, a vest device, a head-mounted device, a console device, an armrest device, a steering wheel device, etc. that is configured to connect with the wearable device 20 when the wearable device 20 is in close proximity to the charging device. For example, when the wearable device 20 is the wrist-mounted device or the glove, the charging device may be the armrest device or the steering wheel device such that the wearable device 20 is capable of receiving a charge while the operator is driving the refuse vehicle 10 with the wearable device 20 in a position corresponding to the operator steering the steering wheel or resting an arm on the armrest. In another example, when the charging device is the seatbelt device, the charging device may provide a charge to the wearable device 20 if the wearable device 20 is positioned on the jacket or the vest of the operator such that when the operator is sitting in the seat with a seatbelt on, the wearable device 20 is in proximity to the position of the charging device on the seatbelt. In some embodiments, the charging device may be a wired charging device.

In another embodiment, the charging device or the wearable device 20 may use the motion of the operator wearing the wearable device 20 to charge the wearable device 20. The motion of the operator wearing the wearable device 20 may be converted into electrical energy to be used to charge the wearable device 20 or prolong the battery life of the wearable device 20.

The charging device or the wearable device 20 may detect motion of the wearable device 20 and convert the motion into electrical energy, charging the wearable device 20 using the electrical energy. For example, if the wearable device 20 worn by the operator is the wrist-mounted device, the motion of the arm of the operator as the operator moves around or performs job tasks can be converted into electrical energy and can charge the wearable device 20.

In yet another embodiment, a method of charging the wearable device 20 may include detecting motion of the wearable device 20, converting the motion of the wearable device 20 into electrical energy, and charging the wearable device 20 using the electrical energy. Charging the wearable device 20 may include “topping up” the charge of the wearable device, charging the wearable device 20 to completion, etc.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A vehicle control system, comprising:
a control system for controlling operation of a vehicle or a working component thereof; and
a wearable device communicatively coupled to the control system and configured to generate wearable data, the control system configured to:
obtain the wearable data;
determine a position of the wearable device relative to the vehicle based on the wearable data; and
control operation of the vehicle or the working component based on the position.

2. The vehicle control system of claim 1, wherein controlling the vehicle comprises enabling, disabling, and limiting a function of the vehicle.

3. The vehicle control system of claim 1, wherein the wearable device comprises one or more of a wrist-mounted device, a glove, a jacket, a vest, a head-mounted device, or a pendant.

4. The vehicle control system of claim 1, wherein the control system is further configured to determine an identity of an operator associated with the wearable device, and selectively control operation of the vehicle or the working component based on the identity.

5. The vehicle control system of claim 1, wherein controlling operation of the vehicle based on the position of the wearable device comprises driving the vehicle.

6. The vehicle control system of claim 1, wherein controlling the working component based on the position of the wearable device comprises controlling a lift assembly or a grabber assembly.

7. The vehicle control system of claim 1, wherein controlling operation of the vehicle or the working component based on the position of the wearable device occurs based on a determination that the position of the wearable device corresponds to a risky location.

8. The vehicle control system of claim 1, further comprising a charging device located within the vehicle and configured to charge the wearable device based on the determination of the position of the wearable device.

9. The vehicle control system of claim 1, wherein the control system is further configured to generate one or more zones around the vehicle.

10. The vehicle control system of claim 9, wherein the control system is further configured to detect a position of the wearable device proximate to a zone of the one or more zones around the vehicle and control an operation of the vehicle or the working component based on a predetermined identity of the zone.

11. The vehicle control system of claim 1, further comprising a vehicle awareness system, wherein the control system is further configured to:
receive data from the vehicle awareness system indicating that an object may come in contact with an operator wearing the wearable device; and
generate an operator alert to the wearable device.

12. The vehicle control system of claim 1, wherein the wearable device is further configured to detect an operator impairment and limit one or more of access to the vehicle or operation of the vehicle or the working component based on the detection of the operator impairment.

13. A charging system for a wearable device, comprising:
a wireless charging device located within a vehicle at a position corresponding to a wearable device and configured to wirelessly charge the wearable device based on a proximity of the wearable device to the wireless charging device, the wireless charging device comprising at least one of a seat device configured to be disposed in a seat of a vehicle, a seatbelt device configured to be disposed in a seatbelt of a vehicle, an armrest device configured to be disposed in an armrest of a vehicle, or a steering wheel device configured to be disposed in a steering wheel of a vehicle.

14. The charging system of claim 13, wherein the wearable device comprises a wrist-mounted device capable of receiving a charge from the steering wheel device while an operator is driving the vehicle.

15. The charging system of claim 13, wherein the wearable device comprises a vest capable of receiving a charge from the seat device while an operator is sitting in the vehicle.

16. The charging system of claim 13, wherein the wearable device comprises a head-mounted device capable of receiving a charge from the seat device while an operator is sitting in the vehicle.

17. The charging system of claim 13, wherein the wearable device is capable of receiving a charge from at least one of the seat device, the seatbelt device, the armrest device, or the steering wheel device when an operator of the vehicle is positioned within the vehicle.

18. A method of charging a wearable device, comprising:
detecting motion of the wearable device;
converting the motion of the wearable device into electrical energy; and
charging the wearable device using the electrical energy.

19. The method of claim 18, wherein detecting motion of the wearable device comprises detecting motion of an arm of an operator wearing the wearable device.

20. The method of claim 18, wherein detecting motion of the wearable device comprises detecting that an operator is moving around while wearing the wearable device.
